(19) United States
(12) Patent Application Publication
(10) Pub. No.: US 2014/0074560 A1
(43) Pub. Date: Mar. 13, 2014

(54) ADVANCED SKILL MATCH AND REPUTATION MANAGEMENT FOR WORKFORCES

(71) Applicant: ORACLE INTERNATIONAL CORPORATION, Redwood Shores, CA (US)

(72) Inventors: REZA B'FAR, HUNTINGTON BEACH, CA (US); KENT SPAULDING, PORTLAND, OR (US); HUYVU NGUYEN, PLACENTIA, CA (US)

(21) Appl. No.: 13/932,304

(22) Filed: Jul. 1, 2013

Related U.S. Application Data
(60) Provisional application No. 61/699,233, filed on Sep. 10, 2012.

(51) Int. Cl. G06Q 50/00; G06Q 10/06

(52) U.S. Cl. CPC G06Q 50/01; G06Q 10/0639
USPC 705/7.38

(57) ABSTRACT

Data regarding members of an organization can be obtained and analyzed to calculate various values related to the reputation of the members and of the organization as a whole. The data sources may include external data sources, such as social network systems, and internal data sources, such as enterprise computer systems supporting the operations of the organization. The calculated values can be used to assist the organization in maintaining its own reputation, in complying with various laws and regulations, and for other activities in support of the organization's activities.

### CROSS-REFERENCES TO RELATED APPLICATIONS

The present application claims benefit under 35 USC 119(e) of U.S. Provisional Application No. 61/699,233, filed on Sep. 10, 2012 by B'Far et al. and entitled “Advanced Skill Match and Reputation Management for Workforces,” of which the entire disclosure is incorporated herein by reference for all purposes.

The present application is also related to the following co-pending and commonly assigned U.S. patent applications:
U.S. patent application Ser. No. ______ (Attorney Docket Number 88325-857739(131100US)) filed concurrent herewith by B'Far et al. and entitled “Personal and Workforce Reputation Provenance in Applications,” and which claims priority to U.S. Provisional Application No. 61/699,250, filed on Sep. 10, 2012 by B'Far et al. and entitled “Personal and Workforce Reputation Provenance in Applications;”
U.S. patent application Ser. No. ______ (Attorney Docket Number 88325-857742(131200US)) filed concurrent herewith by B'Far et al. and entitled “Reputation-Based Auditing of Enterprise Application Authorization Models,” and which claims priority to U.S. Provisional Application No. 61/699,238, filed on Sep. 10, 2012 by B'Far et al. and entitled “Reputation-Based Auditing of Enterprise Application Authorization Models;” and
U.S. patent application Ser. No. ______ (Attorney Docket Number 88325-857743(131300US)) filed concurrent herewith by B'Far et al. and entitled “Semi-Supervised Identity Aggregation of Profiles Using Statistical Methods,” and which claims priority to U.S. Provisional Application No. 61/699,243, filed on Sep. 10, 2012 by B'Far et al. and entitled “Semi-Supervised Identity Aggregation of Profiles Using Statistical Methods,”
   of which the entire disclosure of each is incorporated herein by reference for all purposes.

### BACKGROUND OF THE INVENTION

Modern communications technologies provide numerous opportunities for individuals and organizations to communicate with others in electronic environments. Social networks, for example, allow individual organizations to communicate with groups of individuals and even the general public. Web sites and other electronic information resources often allow members of the public to provide their own content, such as product reviews, opinions on certain topics, technical assistance, photographs, audio files, video files, and other types of content. In addition, the diverse ways in which modern communication technologies operate provide opportunities to gain valuable intelligence that would not otherwise be as freely available. For instance, social networks often allow users to mutually associate themselves with one another. This allows, for example, the collection of information not only about an individual, but about other individuals who have some sort of relationship with the individual. As such, effective use of such communications has the potential to have significant positive effects for the conduct of one's business.

At the same time, the ability to freely communicate using modern technologies has the potential to cause significant harmful effects on one's business. For instance, the conduct of an individual in a public forum can shape others' opinion of an organization associated with the individual. While this can be a positive effect in many instances, unsavory and/or unpopular behavior of the individual can negatively affect the organization. For instance, if an employee of a company uses excessive amounts of profanity and provides negative opinions of his or her employer in public forums, the company can suffer reputational harm, thereby affecting the company's good will with the general public. As another example, if the employee publicly posts information related to confidential dealings of the company, the company can find itself addressing various legal issues, such as securities laws violations. Thus, while modern communications provide numerous opportunities for an organization, such opportunities are not without significant risks.

### BRIEF SUMMARY OF THE INVENTION

Embodiments of the invention provide systems and methods for skills matching and reputation management for a workforce. According to embodiments of the present invention, data regarding members of an organization can be obtained and analyzed to calculate various values related to the reputation of the members and of the organization as a whole. The data sources may include external data sources, such as social network systems, and internal data sources, such as enterprise computer systems supporting the operations of the organization. The calculated values can be used to assist the organization in maintaining its own reputation, in complying with various laws and regulations, and for other activities in support of the organization's activities.

Stated another way, reputation management of employees of an enterprise can comprise obtaining activity data for each of a plurality of employees from each of a plurality of data sources. The plurality of data sources can include at least one data source internal to the enterprise and at least one data source external to the enterprise. Obtaining activity data for each of the plurality of employees can comprise receiving the activity data from each of the plurality of data sources, converting the received activity data, and storing the converted activity data. Converting the received activity data can comprise identifying a portion of the converted activity data as relevant and discarding a portion of the converted activity data other than the portion identified as relevant. In some cases, converting the received activity data can comprise converting the received activity data to a common organizational schema.

A reputation score can be calculated for at least one of the plurality of employees based at least in part on the obtained activity data. Calculating the reputation score for at least one of the plurality of employees can comprises accessing the stored activity data, calculating one or more reputation metrics for the at least one of the plurality of employees based at least in part on the accessed activity data, and calculating the reputation score for the at least one of the plurality of employees based at least in part on the calculated one or more reputation metrics. The one or more reputation metrics can comprise, for example, a plurality of reputation metrics and calculating the reputation score for the at least one of the plurality of employees can comprise calculating a weighted sum of the reputation metrics. In some cases, a weight of each of the reputation metrics can be user-configurable. An indication of one or more selected employees of the plurality of employees can be received and the reputation metrics of the one or more selected employees can be assessed. A presentation can be generated based on the accessed reputation metrics and the generated presentation can be provided to a user.

### BRIEF DESCRIPTION OF THE DRAWINGS

FIG. 1 shows an illustrative example of an environment in which various embodiments of the present disclosure may be practiced;

FIG. 2 shows an alternative illustrative example of the environment of FIG. 1 in which various embodiments of the present disclosure may be practiced;

FIG. 3 shows example steps of a process for providing a presentation of data analysis in accordance with at least one embodiment;

FIG. 4 shows example steps of another process for providing a presentation of data analysis in accordance with at least one embodiment;

FIG. 5 shows example steps of another process for providing a presentation of data analysis in accordance with at least one embodiment;

FIG. 6 shows an example presentation of data analysis in accordance with at least one embodiment;

FIG. 7 shows an example presentation of data analysis in accordance with at least one embodiment;

FIG. 8 shows example steps of another process for providing a presentation of data analysis in accordance with at least one embodiment;

FIG. 9 shows an example presentation of data analysis in accordance with at least one embodiment;

FIG. 10 shows an example presentation of data analysis in accordance with at least one embodiment; and

FIG. 11 shows an example computer system that may be used to implement various aspects of the present disclosure.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

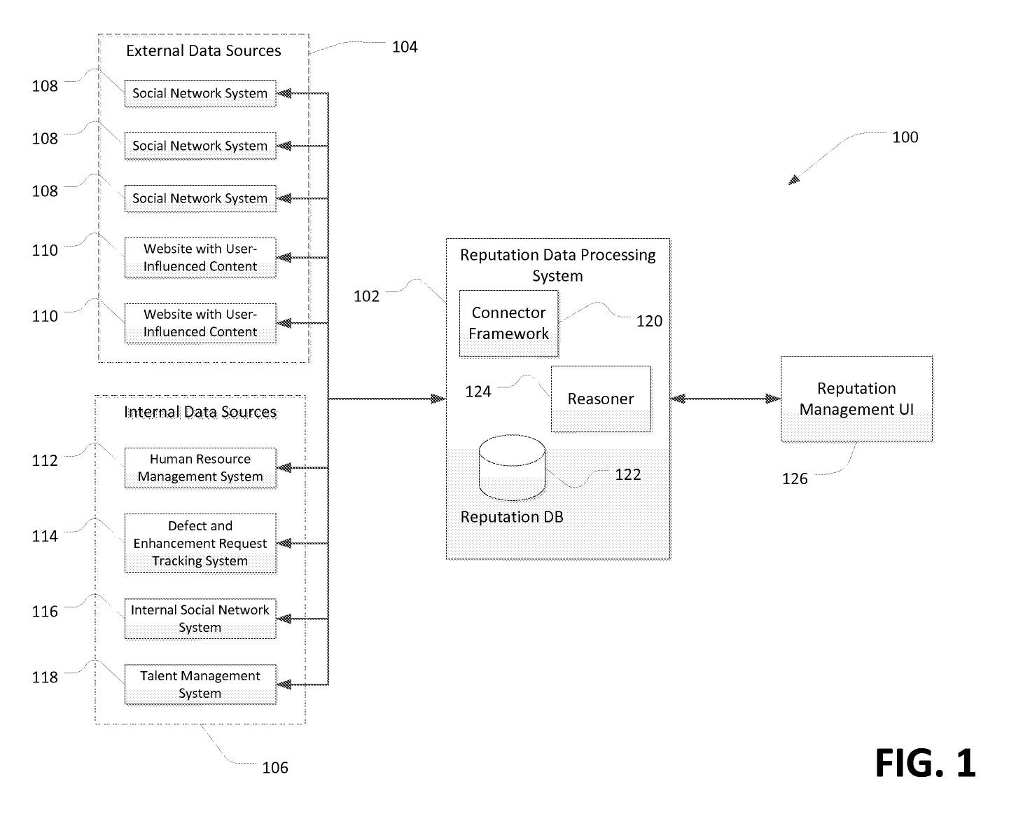

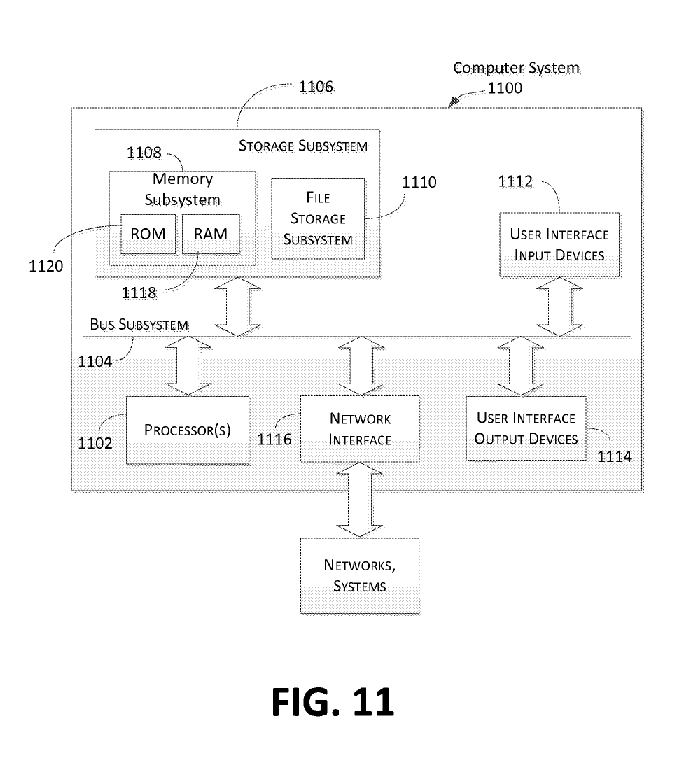

FIG. 1 shows an illustrative example of an environment 100 in which various embodiments of the present disclosure may be practiced. In this example, the environment 100 includes a reputation data processing system 102. The reputation data processing system 102 may be one or more computer systems collectively configured to operate in accordance with various embodiments of the present disclosure, such as those embodiments discussed below. An example of such computer system is described below in connection with FIG. 11. In the illustrative example of FIG. 1, the reputation data processing system is configured to obtain data from external data sources 104 and internal data sources 106.

The reputation data processing system 102 may be operated by an organization or on behalf of the organization. As such, external data sources 104 may be computer systems serving as a source of data where the computer systems are operated by and/or on behalf of entities different from the organization. Similarly, internal data sources 106 may be computer systems serving as sources of data where the computer systems are operated by and/or on behalf of the organization. It should be noted that the various data sources, internal and external, may be hosted in various ways. For example, one or more of the internal data sources may be hosted by the organization itself, such as in a data center or other facility of the organization. One or more of the internal data sources may be hosted by third parties. For example, one or more of the internal data sources may operate using facilities and hardware of a third party, yet may be programmatically managed by or on behalf of the organization. The hosting of external data sources may also vary in these ways.

Turning to the external data sources, example data sources include social network systems 108. A social networking system may be a publicly accessible computer system having users from the general public. The term “computer system,” unless otherwise contradicted explicitly or by context, is intended to encompass both single computer instances (e.g. a single server) and multiple computer system instances, such as a network of computer system instances that collectively operate to achieve a result. Further, a computer system may also encompass multiple computer system instances that span multiple geographic regions and/or data center facilities. Returning to an example social networking system 108, the users of the social networking system may have accounts and corresponding profiles with the social network systems 108 and may engage in social networking activities. Example social networking activities include communicating electronically with other users of a social network system, either privately or publicly, expressing interest in content, and/or associating profiles with other profiles of the social network system which may be pursuant to mutual acceptance of the association by corresponding users. Specific examples of social networking systems include Facebook®, Twitter®, MySpace®, and others. Some specific examples of social networking activities in the Facebook social network system include friending other users, posting content on another's wall, liking content and/or other users, public or private messaging, un-friending other users, sharing content, and other activities. Example activities in the Twitter social network system include following other users, being followed by other users, tweeting, re-tweeting, and the like.

Generally, any suitable external data source may be used in accordance with various embodiments of the present disclosure. For example, as illustrated in FIG. 1, various websites 110 with user-influenced content may also serve as external data sources for the reputation data processing system 102. A website with user-influenced content may be any public information resource in which content is associated with users of the website. An example website may be an online forum in which users of the forum submit messages for other users to see. Another example of a suitable website is an electronic marketplace in which users of the electronic marketplace are able to electronically provide feedback for other users of the electronic marketplace. For example, one user may purchase a product or otherwise have knowledge of the product and may provide an electronic review of the product for other users to see in connection with their purchasing decisions.

As with external data sources 104, internal data sources 106 may comprise one or more computer systems serving as an internal source of data for the reputation data processing system 102. Typically, organizations utilize various computer systems in connection with management of their operations. An organization, for example, may utilize various computer systems for accounting, human resources, talent management, customer relationship management, internal social networking, internal information sources (e.g. internal websites), and the like. FIG. 1 shows some illustrative examples of suitable internal data sources 106 in accordance with an embodiment. For example, as shown in FIG. 1, the internal data sources 106 include a human resource management system 112 which may be a computer system configured to perform various operations in connection with management of an organization's human resource needs.

The human resource management 112 may, for example, maintain data about employees of the organization and may allow administrators to update, add, and/or remove data for employees of the organization as the set of employees of the organization changes over time. Another example of a suitable internal data source 106 is a defect and enhancement request tracking system 114. A defect and enhancement request tracking system 114 may be a computer system which tracks various issues with products and/or services of the organization. For example, if the organization is a software company, the defect and enhancement request tracking system may enable employees to submit information identifying issues with the software otherwise known as bugs. The defect and enhancement request tracking system may also enable employees to submit information regarding bugs of internal computer systems used by the organization and not necessarily sold to others. For example, an employee may notice a broken link on an internal web page of the organization and, as a result, may submit a ticket which may then be processed by another employee of the organization who may update the internal website accordingly.

As illustrated in FIG. 1, the internal data sources also include an internal social network system 116. The internal social network system 116 may not be publicly accessible. That is, the universe of users of the internal social network system 116 may be limited, such as to employees of the organization, certain employees of the organization and/or individuals and/or computer systems to which the organization has provided authorization. As an example, the internal social network system 116 may be accessible to employees of the organization and certain vendors of the organization such as attorneys working in law firms for the organization. It should be noted and understood that, while referred to here as an “internal” social network system, this system may or may not be hosted internally. That is, it may actually be a hosted outside the company, but have a limited universe of employees, i.e., accessible by internal people.

Also as illustrated in FIG. 1, the internal data sources 106 include a talent management system 118. A talent management system may be a computer system configured to enable employees of the organization to perform various operations in connection with ensuring that the organization has appropriate personnel. For example, an employee of the organization may utilize the talent management system to track individuals who are engaged in the hiring process of the organization and/or to locate candidates for open positions. The talent management system may maintain resumes, may perform automated processing of received resumes, and the like. Example talent management systems include those offered under the brand name Taleo. It should be noted and understood that this system might be hosted elsewhere, but would considered “internal” in the sense that only “internal” people have access to this system.

As noted above, numerous variations of the environment 100 are considered as being within the scope of the present disclosure. For example, while FIG. 1 shows various illustrative examples of external data sources 104 and internal data sources 106, numerous embodiments of the present disclosure may have more or fewer data sources than those explicitly illustrated.

Turning to the reputation data processing system 102, in an embodiment, the system includes multiple components. For example, as illustrated in FIG. 1, the reputation data processing system 102 includes a connector framework 120. The connector framework 120 of the reputation data processing system 102 may be a component (e.g. separate computer system instance(s) or programming module) configured to enable the reputation data processing system 102 to obtain data from the external data sources 104 and internal data sources 106. The connector framework 120 may, for example, operate according to programming logic that enables the connector framework 120 to obtain data from numerous different data sources and combine the data in a manner suitable for processing by the reputation data processing system such as described below.

For example, many of the external data sources 104 and/or internal data sources 106 may provide data that is organized in different ways. The connector framework 120 may include programming logic to extract data and store data from multiple sources in a common manner such as in accordance with a common data storage schema. The connector framework may obtain data from the various data sources in numerous ways. For example, in an embodiment, the connector framework is configured to obtain data from the various data sources according to application programming interfaces (APIs) of the various systems. For example, a social network system 108 may include an API for obtaining data available in the API. The connector framework may include programming logic for making API calls in a manner acceptable to the social network system. Different social network systems may have different APIs and the connector framework may be configured appropriately to obtain data from the different sources.

The connector framework 120 may also be configured to obtain data in other ways. For example, data posted on web pages may be obtained by downloading web pages or other documents of the data source. For instance, a website may correspond to a domain name. The connector framework 120 may enable the reputation data processing system to obtain a web page or other document by using the URL. The connector framework may analyze and receive documents and store data accordingly. The connector framework 120 may also utilize various screen scraping techniques and generally any technique in which data from a data source may be obtained.

As noted above, the connector framework 120 in an embodiment enables the reputation data processing system to obtain data from various different sources and store the data according to a common schema or generally in a manner suitable for use by the reputation data processing system. In an embodiment as illustrated in FIG. 1, the data received through the connector framework 120 is stored by the reputation data processing system into a reputation database 122. The reputation database may be any data storage mechanism that enables the reputation data processing system to operate in accordance with the various embodiments described herein.

The reputation database may, for example, be a relational database comprising a computer system that utilizes storage to store data in multiple tables, where the tables associate some of the data with other data. For example a table may associate an identifier of an employee with data collected about the employee, such as data regarding the employee's activity in a social network and/or other electronic environment. According to some embodiments, much of the collected data can be stored in a triple-store (aka a graph database) and the remainder in a relational database. In such a mixed model, data can be stored based on how it will be analyzed later, i.e., it can be stored where future analysis will be most efficient. Once data is obtained from multiple sources and stored in the reputation database 122, a reasoner 124 of the reputation data processing system may process data accessed from the reputation database 122. The reasoner accordingly may be a component of the reputation data processing system that is configured to analyze data from the reputation database in accordance with the various embodiments described herein.

The reasoner 124 may, for example, analyze data from the reputation database 122 in order to determine an individual influence based on the data that was obtained about the individual. Similarly, the reasoner 124 may be used to decide which data is stored persistently in the reputation database 122. For example, the connector framework 120 in an embodiment may obtain more data than is necessary and/or desirable for use in accordance with the various embodiments. The reasoner 124 may accordingly analyze data to determine whether to discard the data or store the data in the reputation database 122.

In an embodiment, the environment 100 includes a reputation management user interface 126, which enables users of the reputation data processing system 102 to engage in various activities, such as by defining data analysis for the data processing system 102 to perform, specifying data sources and which data is to be obtained from the specified data sources, specifying parameters for maintaining data (e.g. how much data to store for each user, how to determine which data to keep and which to discard, and the like), viewing presentations of data and results of analysis of the data by the reputation data processing system 102, generating white label applications for data sources, and other activities. In an embodiment, the reputation management user interface 126 is an application operating on a computer system instance separate from the reputation data processing system 102, obtaining data for presentations and/or the presentations themselves from the reputation data processing system 102. The reputation management user interface 126 may be an application constructed using application development framework (ADF) tools, such as those available from Oracle Corporation. However, the reputation management user interface 126 may be any suitable application and, in some embodiments, the reputation management user interface is presented in a web browser, presenting presentations obtained from a web server of the reputation data processing system 102 (e.g. in the form of HTML pages). Also, while illustrated separately from the reputation data processing system 102, the reputation management user interface 126 may be a component of the reputation data processing system 102. For example, if the reputation data processing system is operated as a server or cluster of servers, the reputation management user interface 126 may be a module of the reputation data processing system 102 implemented by the server and/or one or more of the servers of the cluster.

The reputation management user interface 126 may also be separate from the reputation data processing system 102. For instance, the reputation management user interface 126 may be implemented by a server different from a server or cluster of servers that implements the reputation data processing system 102. Similarly, the reputation management user interface may be implemented as multiple components implemented themselves on different hardware devices. For example, the reputation management user interface 126 may be implemented collectively by a server and a client application executing on a hardware device of a user of the reputation management user interface 126. In an embodiment, the reputation management user interface enables users to view presentations of data and results of analysis of the data.

In an embodiment, the presentations presented by the reputation management user interface 126 include graphics and/or text which provide intuitive views of data in the reputation database and/or results of analysis of that data. In an embodiment, a user of the reputation management user interface provides user input that is transmitted to the reputation data processing system 102. The reasoner 124 may then process data from the reputation database 122 in accordance with the user input. Results of processing by the reasoner 124 may be provided to the reputation management user interface 126 for presentation to the user. Similarly, input by the user may be transmitted to the reputation data processing system 102 which may submit a query to the reputation database 122 to obtain data stored by the reputation database 122 which is then provided either directly or in a processed form to the reputation management user interface 126 for presentation to the user.

User input into the reputation management user interface 126 may also cause results from the reasoner 124 and data from the reputation database 122 to be provided for presentation to the user. Plus, in general, in an embodiment, the representation management user interface enables users to direct operation of the reputation data processing system 102 in accordance with its programmed capabilities. Additional capabilities may include, for example, obtaining data from a data source in response to user input provided to the reputation management user interface 126.

In various embodiments, the reputation management user interface 126 includes one or more additional features. For example, in an embodiment, the reputation management user interface 126 includes reusable ADF and/or API components that allow others to build additional applications that make use of data and analysis through the reputation data processing system 102. Reputation metrics and other values calculated by the reputation data processing system 102 may be used, for instance, to serve other purposes in addition to those described explicitly herein. For instance, reusable ADF components of the user interface 126 may be used to build a custom application for a marketing department to enable users in the marketing department to hone their skills and view how their activities serve their reputations and the reputations of the organization as well as how their activities may cause undue risk to the organization.

As another example, in some embodiments, the reputation management user interface 126 includes functionality to generate white label applications for one or more social networking systems and/or other system. A white label application built for a social network system may, for example, be installed by a user as a condition for receiving one or more rewards or other recognition. An example of such rewards may be a restaurant or retailer discounts. In such cases, if an employee shares more information, they may, in some embodiments, receive larger discounts, discounts at a larger set of retailers, or unlock extra coupon codes. Once installed, the white label application may give the organization access to information maintained by the social network system in a non-public manner. For example, using Facebook as an example, use of the white label application may give the organization access to information that is not accessible to the general public, but to a more limited group of Facebook users, such as those identified as friends of the user that installed the white label application. In an embodiment, the white label application allows the user to specify various privacy settings that determine how much and which types of information are shared with the organization. In some embodiments, the white label application is a wrapper for a benefit management application such that benefits to the employee may vary according to the amount of information shared by the employee. In this manner, the employee can choose the level of benefits and information sharing that he or she is most comfortable with.

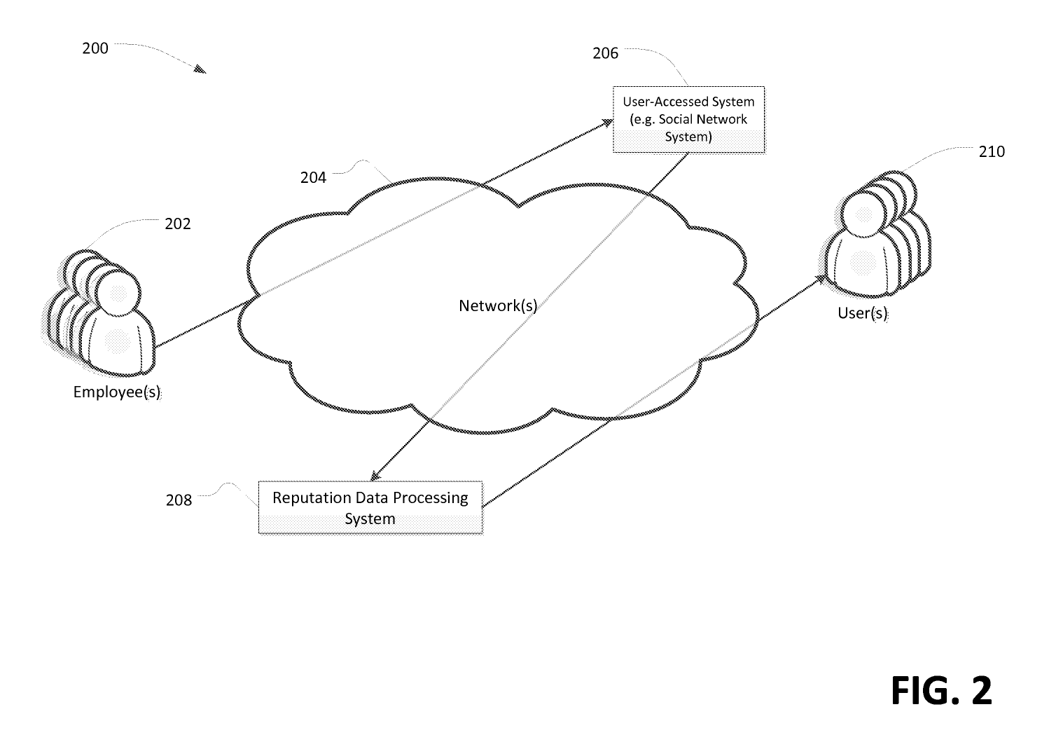

FIG. 2 shows an illustrative example of an environment 200 in which various embodiments of the present disclosure may be performed. Environment 200 may be the environment 100 described above in connection with FIG. 1 or another environment. In the environment 200, employees 202 of an organization utilize one or more networks 204 to access a user-accessed system 206. The network 204 may be the Internet and an intranet, a mobile communications network and generally any suitable communications network or combination of networks. User-accessed system 206 may be an internal or external data source such as described above. For example, in an embodiment the user-accessed system may be a social network system.

The employees 202 of the organization may access the user-accessed system using various devices. Example devices include: personal computer systems, mobile devices such as smart phones, tablet computing devices and generally any device configured to communicate with the user-accessed system 206. As shown in FIG. 2, a reputation data processing system 208, such as the reputation data processing system described above in connection with FIG. 1, obtains data from the user-accessed system 206. For example, the reputation data processing system 208 may submit an API call to the user-accessed system 206 which may provide a response accordingly with data specified by the API call.

For example, the reputation data processing system 208 in an embodiment may submit an API call to obtain data about an employee 202 specified in the API call. The API call may, for example, specify a user name utilized by the employee when accessing the user-accessed system 206. Accordingly, the reputation data processing system 208 in an embodiment may maintain data that associates internal identifiers of employees with corresponding user names of the user-accessed system 206. It should be noted, however, that the reputation data processing system and the user-accessed system may utilize the same identifier for a single employee. For example, the user-accessed system may be an internal system of the organization and a single identifier may be used by the reputation data processing system 208 and the user-accessed system 206.

As noted above, the reputation data processing system 208 may obtain data from the user-accessed system 206 in other ways such as by requesting a web page of the user-accessed system 206 and processing data from the web page accordingly. In another example, the reputation data processing system may request data in batches. For example, the organization may maintain an account with the user-accessed system 206. The reputation data processing system 208 may then, for example, submit an API call requesting current data for the account such as data for all employees of the organization having an account with the user-accessed system 206. Generally, the reputation data processing system 208 may obtain data from the user-accessed system 206 in any suitable manner including in manners not explicitly described herein. In addition, the data processing system may determine which received data to store in a persistent manner.

Data that has been stored and/or processed by the reputation data processing system 208 may be accessed by users 210 of the organization and/or users acting on behalf of the organization. Such users may be users interested in compliance of the organization, reputation of the organization and hiring for the organization and/or generally any users who utilize the reputation data processing system as part of their activities. Users may access the reputation data processing system through a browser or other application configured to submit requests for presentations of data to the reputation data processing system 208 which may then provide appropriate responses to the users.

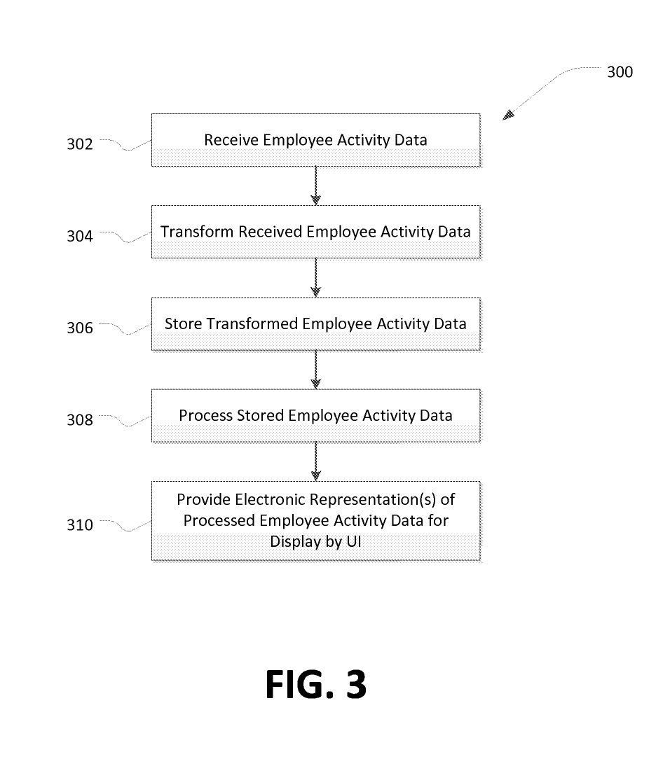

FIG. 3 shows an illustrative example of a process 300 for providing information in accordance with various embodiments. The process 300 may be performed, for example, by a reputation data processing system such as described above. Some or all of the process 300 (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

In an embodiment, the process 300 includes receiving 302 employee activity data. Employee activity data may be any data generated as a result of employee interaction with a different computer system such as with a social network computer system, with a website with content provided by or otherwise influenced by the employee and the like. Generally the received employee activity data may be received in any suitable manner such as in one or more manners described above in connection with FIGS. 1 and 2. It should be noted that while not illustrated as such, other data may also be received such as data maintained by an organization about the employee which may not necessarily correspond to activity by the employee with other computer systems.

In an embodiment, when the employee activity data is received 302, at least some of the received employee activity data is transformed 304 into a suitable form. Transforming the received employee activity data may involve, for instance, converting some or all of the received employee activity data from one schema to another schema. Transforming the received employee activity data may also include selecting relevant data from the received employee activity data thereby discarding data which is undesirable and/or otherwise unwanted. Generally, transforming the received employee activity data may be performed using any transformation useful in particular embodiments. Further, it should be noted that, while not illustrated as such in FIG. 3, some data may be received and left untransformed, such as when the data is received in a form that is already suitable for use.

As noted above, transforming the received employee activity data may include transforming data organized in various different ways into a common organizational schema. In an embodiment, the transformed received employee activity data is stored 306. Storing the transformed employee activity data may include transmitting the transformed employee activity data to a database for storage where the database organizes the data in a manner suitable for processing. Storing the transformed employee activity data may also be performed in other ways such as by storing the transformed employee activity data in persistent or non-persistent storage depending on how the data is maintained in accordance with the various embodiments.

As illustrated in FIG. 3, the process 300 includes accessing the stored employee activity data and processing 308 the accessed data, possibly in connection with other data obtained from another source. Processing the stored employee activity data may be performed in numerous ways in accordance with the various embodiments. For instance, the stored employee activity data may be analyzed to determine a value for a reputation of the employee and generally to calculate one or more reputation metrics for the employee. Once the stored employee activity data is processed 308, one or more electronic representations of the processed employee activity data may be provided 310 for display by a user interface.

Providing one or more electronic representations may be performed in any suitable manner and the manner in which providing the electronic representations is performed may vary according to the various embodiments. For instance, in some embodiments, providing the electronic representations includes generating web pages that are transmitted over a network to a computing device that submitted a request for the web pages. As another example, if the user interface is implemented on the same computer system that processes the stored employee activity data, an electronic representation of the processed data may be provided to a display device utilized by the user.

It should be noted that the various actions described in connection with FIG. 3 may be performed at various times in accordance with the various embodiments. For example, in some embodiments, processing the employee activity data is performed on demand, that is, in response to requests to process the data. Thus a user may provide user input that is used to generate a request for processing of the stored employee activity data and, as a result of that request, electronic representations may be provided. As another example, in some embodiments, the stored employee activity data is processed and stored, such as by caching. Upon request of a user, the electronic representations of the processed employee activity data may be retrieved from data storage and be provided. As yet another example, some representations may be generated upon demand, whereas others may be generated in advance and retrieved from storage on demand. Other examples of how the timing of various actions of the process 300 varies include employee activity data being received in advance and/or on demand. Generally any of the actions described in connection with FIG. 3 may be performed in advance and/or on demand, depending on how various systems implementing the various embodiments are implemented.

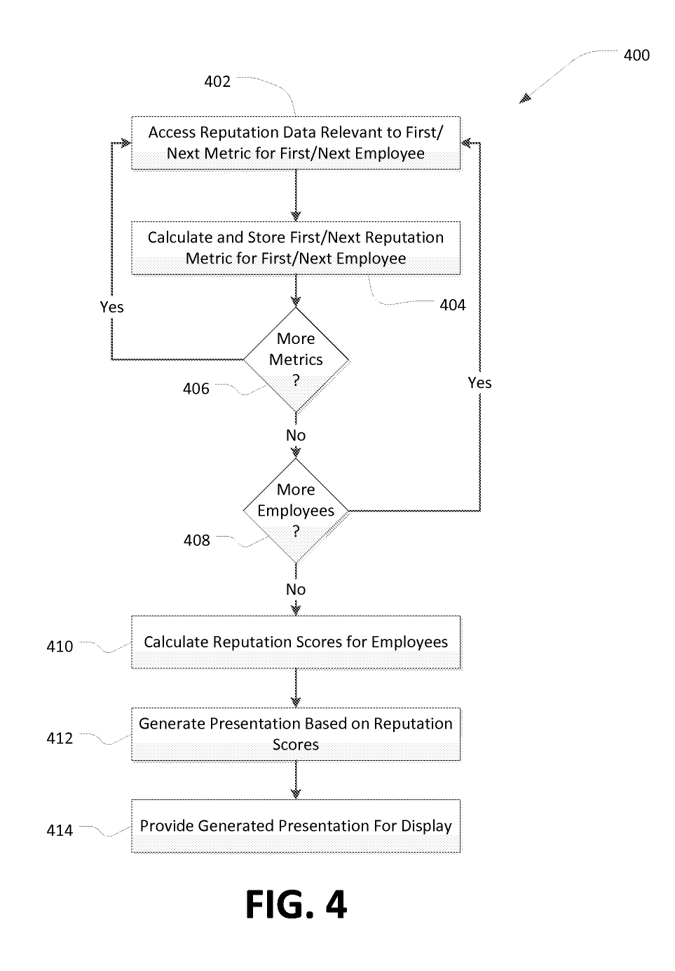

As discussed above, various embodiments of the present disclosure include calculating various reputation metrics for employees of an organization. FIG. 4 accordingly shows an illustrative example of a process 400 for providing presentations of such reputation metrics in accordance with at least one embodiment. As illustrated in FIG. 4, the process 400 includes accessing 402 reputation data relevant to a first metric for a first employee. Accessing the reputation data may be performed in any suitable manner, such as retrieving from an external or internal data source and/or retrieving from data storage, such as from a reputation database such as described above in connection with FIG. 1.

In an embodiment, once the reputation data is accessed 402, the reputation data is processed and a first reputation metric is calculated and stored 404 for the first employee. A determination may then be made 406 whether there are more metrics to calculate for the first employee. If there are reputation data, the next metric is accessed for the first employee and a next reputation metric is calculated and stored for the first employee. In some cases, metrics for a first employee can be determined by the activities of one or more other employees. That is, if people regularly mention employee A, rewet employee A posts, or tag photos of employee A, that can affect the metrics for this employee.

This process may continue until it is determined 406 that there are no more metrics to calculate for the first employee. At this point, a determination may be made 408 whether there are more employees for which reputation metrics should be calculated. If there are additional employees, the above process may continue for additional employees as illustrated in FIG. 4. This process may continue until a determination is made 408 that there are no additional employees.

At this point, in an embodiment, the process 400 includes calculating 410 reputation scores for the employees. The reputation scores may be calculated in any suitable manner using various techniques for calculating reputation. For example, it should be noted that one or more reputation scores may be calculated for each employee. The reputation scores may be, or be based at least on, the reputation metrics. For example, in an embodiment, reputation scores are calculated as a function of one or more reputation metrics. The function may be configured such that an increase in a particular reputation metric indicative of an improved reputation causes an increase in the reputation score. Similarly, a decrease in the particular reputation metric can cause a decrease in the reputation score. The function may be, for example, a weighted sum (e.g. linear combination) of reputation metrics (or based at least in part thereon) and, in some embodiments, the weights are user-configurable.

In an embodiment, once the reputation scores are calculated a presentation based on the reputation scores is generated 412 and the generated presentation is provided 414 for display such as described above. Example presentations are discussed below.

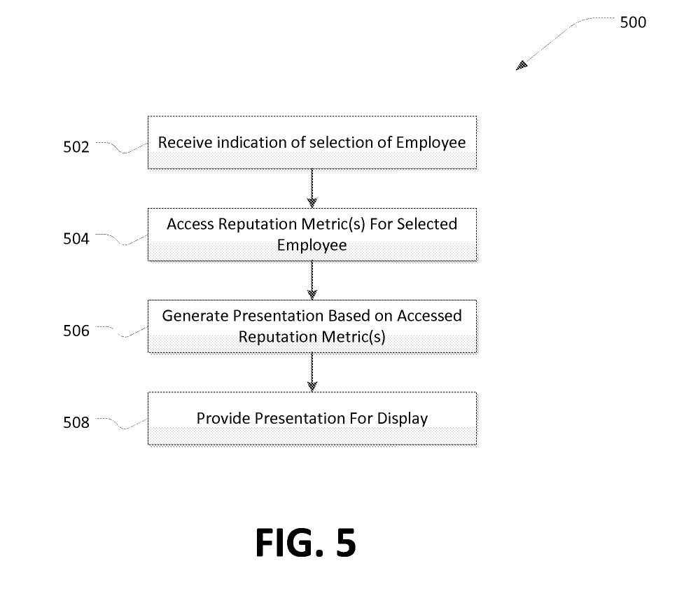

As noted, various embodiments of the present disclosure include generating presentations relevant to a single employee and/or presentations relevant to a group of employees, such as employees of the organization as a whole or a subset thereof such as employees of a department of the organization. FIG. 5 accordingly shows an illustrative example of a process 500 for providing presentations relevant to a single employee in accordance with various embodiments.

In an embodiment the process 500 includes receiving 502 an indication of a selection of an employee. Receiving an indication of selection of employee may be performed in any suitable manner. For example, as noted, users of a user interface may interact with the user interface to provide user input. Such interaction may include selection of a name or other identifier of an employee. Such selection may cause the transmission of one or more signals that indicate the selection and that are processed accordingly. One or more reputation metrics for the selected employee may then be accessed 504. A presentation may then be generated 506 based upon the accessed reputation metrics. Examples appear below. Accordingly, the generated presentation may be provided 508 for display.

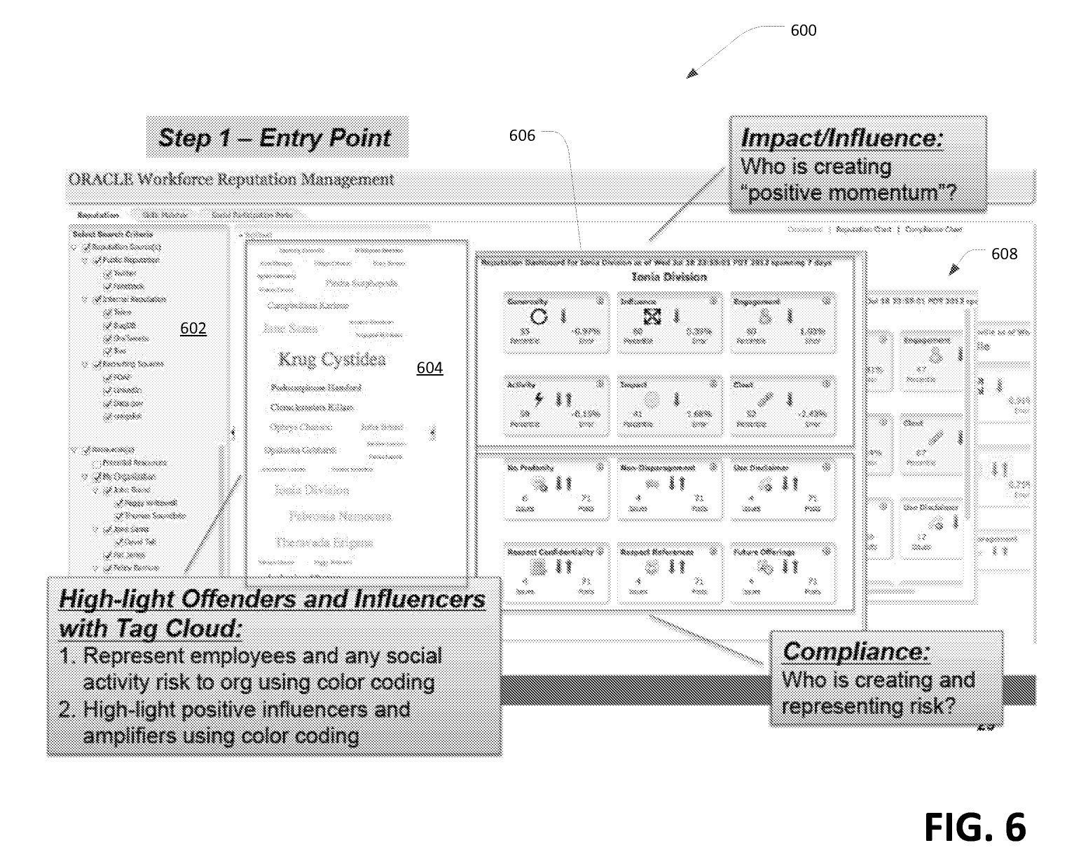

Presentations generated in accordance with the present disclosure may relate not only to individual employees, but also to groups of employees. FIG. 6 accordingly shows an illustrative example of a presentation 600 of data in accordance with an embodiment. As with other presentations described herein, the presentation 600 may be generated by a reputation data processing system, such as described above. As illustrated, the presentation 600 of FIG. 6 shows a graphical representation of data displayed by a user interface of an application such as the user interface described above in connection with FIG. 1.

As illustrated, the example presentation 600 includes numerous components that enable a user to view and/or interact with data. For example, in an embodiment, the presentation 600 includes a search criteria selection component 602. The search criteria selection component 602, in an embodiment, enables a user to make selections that define criteria for data to be displayed in the presentation 600.

For example, as illustrated in FIG. 6, the search criteria selection component 602 enables users through the use of user interface check box components to select which data sources are used to obtain data which is analyzed to make data presentation 600. In addition, the search criteria selection component 602 enables, in this example, also through check boxes, user to select individuals and/or groups for whom data is analyzed and presented in the presentation 600. In an embodiment, a user may check and uncheck check boxes of the search criteria selection component 602, which may cause the transmission of signals to an application that generated the presentation 600 (e.g. an application of a reputation data processing system) to generate an updated presentation, such as in accordance with the above description.

Numerous variations are considered as being within the scope of the present disclosure. For example, each time a user selects or unselects a check box of the search criteria selection component, a signal may be transmitted to the application for updating the presentation 600. The application may then provide an updated presentation 600. As another example, user may interact with the check boxes and when satisfied may click a submit button or otherwise interact with the user interface to cause a signal to be transmitted to the application for updating the presentation 600. In this manner, the presentation 600 is updated when the user is finished modifying the search criteria defined by the search criteria selection component 602.

It should also be noted that check boxes provided in a hierarchical manner (i.e. with selectable attributes organized hierarchically according to their relationship with one another) are shown for the purpose of illustration, although other user interface elements may be used, such as radio buttons and/or hyperlinks and/or generally any way of enabling user interaction with the user interface may be provided.

As shown in FIG. 6, the presentation 600 includes a tag cloud 604. The tag cloud 604 in an embodiment includes the names of employees specified by the search criteria selection component. In addition, in an embodiment, the names in the tag cloud are provided in a visually distinguishing manner where the names are illustrated with an appearance that is determined by the processing of data such as described above.

For instance, as illustrated in FIG. 6, names in the tag cloud 604 are provided with different sized fonts. Font may correspond to a particular reputation metric. For example, there may be a linear or other relationship between font size and the metric. For instance, if the metric indicates influence of the individual whose name is illustrated, the font may be larger if that employee is determined to have a larger influence on his or her peers, and/or generally within some community. In addition, the names in the tag cloud 604 may vary by color, where color corresponds to the various reputation metrics. For example, a name may be shown in red if a reputation metric determines that the employee poses some risk to the organization. For instance, a determination that the employee's credit score has been falling may cause a name to be shown in red.

Generally, names and/or other indicators of employees may vary in many visual and other ways in order to distinguish the names according to reputation metrics. In addition, in an embodiment, the way in which names are varied may be user-defined. For instance, a user may interact with the user interface to determine how colors vary according to various reputation metrics and may determine which appearance characteristics vary in connection with which reputation metrics. In addition, the appearance of items in the tag cloud may vary indirectly according to various reputation metrics. As one example, a characteristic of appearance may vary according to a reputation score (and/or risk score) that is calculated based at least in part on multiple reputation metrics.

It should be noted that while employee names are shown in the tag cloud for the purpose of illustration, other indicators of employees may be used. For example, photographs or other images of the employees may be used instead of or in addition to names. In addition, in some instances it may be useful or desirable to obscure the names and other information such as opaque identifiers or fake names may be used instead of real names in order to, for example, protect privacy.

In an embodiment, the presentation 600 includes a reputation metric panel 606 which provides a graphical illustration of one or more reputation metrics of a selected employee or group of employees. In this particular example, information for an employee named Ionia Division is shown. As illustrated in FIG. 6, the reputation metric panel 606 includes an upper portion corresponding to reputation metrics relating to impact and/or influence and a lower subpanel corresponding to one or more reputation metrics relating to compliance and/or risk of the organization.

Beginning with the upper panel relating to impact and/or influence, in this example, six reputation metrics are shown. The reputation metrics shown are generosity, influence, engagement, activity, impact and clout. Each of these metrics are provided in an example with a box including data about that particular metric.

For example, FIG. 6 shows a box labeled as Generosity. Generosity may be a reputation metric calculated based at least in part on a relative number of times the employee makes an effort to promote content of another. Examples of efforts to promote the content of another include sharing, in a social network (e.g. Facebook), content posted by another, re-tweeting a tweet in the Twitter social network, and otherwise taking action that promotes something of another. Generosity may be a relative value and, therefore, dependent on the actions of others. Generosity for an employee may be, for instance, calculated relative to other employees in a group, such as the whole organization, a department, employees sharing one or more characteristics (e.g. job title), and/or the like. Accordingly, to illustrate the relative nature of Generosity, a percentile score is given that shows how the employee's generosity metric compares to others.

The influence box, in an embodiment, corresponds to an influence value that measures, in a relative manner, how often others promote the content of the employee. The influence value may be, for example, based on the number of tweets of the employee that are re-tweeted in the Twitter social network, the number of posts or other content of the employee that are shared in the Facebook social network, and/or other actions taken by others with respect to content associated with the employee. As with the generosity value and other values herein, the value may be calculated relative to a defined universe of users, which may or may not be limited to users of the organization.

The engagement box, in an embodiment, corresponds to an engagement value that may be a relative value calculated based at least in part on actions taken by the employee that indicate engagement with others. Examples include commenting on content posted by others in various social networks, clicks on articles posted by others (to indicate having read the articles), and/or other actions determined to correspond to engagement by the employee.

The activity box, in an embodiment, corresponds to an activity value that may be a relative value that is based at least in part on the number of times the employee posts content in one or more social networks relative to other users in some defined universe of users. The impact box, in an embodiment, is similar to the influence box. Data for the impact box may be, for instance, calculated based at least in part on the influence value and additionally based at least in part on the size of the employee's social network. For example, the impact value may be based at least in part on the number of followers of the employee in the Twitter social network and at least in part on the number of times a follower re-tweets tweets of the employee. Thus, the impact value may be a relative value that increases both with increased social network size or increased activity of others in connection with content posted by the employee.

The clout box, in an embodiment, corresponds to a relative value that is calculated using search engine metrics. In particular, search histories of users in a defined universe of users may be obtained to determine the frequency at which content of the employee appears in search results responsive to search queries submitted by others. The appearance of such content in search response rankings may also be used. Thus, the clout box, in an embodiment, corresponds to the clout of an employee as measured by the appearance of the employee's content in search responses. As with generosity and other metrics discussed above, this value may be calculated relative to a defined group of employees. Accordingly, a percentile value for the clout box is shown demonstrating the employee's clout relative to others in the defined group. Further, the search engines may be operated by third parties.

Turning to the lower compliance panel of the reputation metric panel 606, various metrics relating to compliance are represented by rectangular boxes in the same manner described above, with the impact and/or influence subpanel. In this example, reputation metrics for “no profanity,” disparagement, disclaimer use, confidentiality respect, reference respect and future offerings are provided. The no profanity box may be (i.e. data for the no profanity box may be) based at least in part on a profanity value that is calculated based at least in part on the number of posts of content by the employee and the number of those posts that contain a word considered to be profane. (Unless otherwise clear from context, a post is to be understood generally and includes activity such as tweets and other activity of making content available.) Whether a word is profane may be determined, for instance, by searching the content of the employee for words on a list of profane words. The “no profanity” metric may be calculated as (or at least based at least in part on) the ratio of posts of the employee containing profanity to the total number of posts of the employee. As with other metrics, posts may be calculated with respect to one or more social networks or other information sources.

The non-disparagement box, in an embodiment, corresponds to a disparagement value. The disparagement value may be calculated similar to the “no profanity” value, but instead of posts containing profanity being used, posts containing disparaging words and/or phrases are used. Determining whether a post contains disparaging words and/or phrases may be performed using semantic analysis of the posts, for instance by stemming words in the posts and searching for similar words in the same semantic topics. In other words, determining whether the posts contain disparaging words and/or phrases may be performed by determining whether the posts contain phrases that are semantically similar to known disparaging words and/or phrases.

The “use disclaimer” box, in an embodiment, corresponds to a measure of activity relating to an employee's web log(blog), if the employee has a blog. An organization's social media policy may, for example, require bloggers that are also employees to make clear that the opinions expressed in the blog are not necessarily those of the organization. The employee may be required, for example, to include a predetermined disclaimer in each blog post and/or in a “terms and conditions” or other portion of a web site. The “use disclaimer” box, therefore, in an embodiment, may correspond to a value that is calculated based at least in part on the number of blog posts and the number of blog posts analyzed and calculated to lack the required disclaimer.

The “respect confidentiality” box, in an embodiment, as with other boxes, corresponds to a measure of certain activity calculated to contain one or more issues. In this instance, an issue is an instance of a post that, either inadvertently or intentionally, contains information that should be confidential. For example, posts containing the name of a company in which the organization is in confidential merger discussions may be marked as issue posts. Similarly, posts containing information about a future product release may be marked as issue posts. Determining whether a post contains confidential information may be performed by searching the posts for keywords of a list of keywords corresponding to confidential information. Such lists may be maintained by one or more individuals tasked with maintaining the organization's confidentiality. In addition, steps to obscure the terms from an administrator (e.g. user of the UI shown in FIG. 6) may be taken. For example, the administrator may be provided a list with dummy words and/or phrases. A reputation data processing system may convert the dummy words/phrases to actual words/phrases outside of the view of the administrator. Other ways of obscuring confidential information may also be used. Activities that may be examined for issues may include posts, articles, tweets, and/or generally any information made available to an unauthorized audience (e.g. the public and/or even those without authorization within the same organization).

The “respect references” box, in an embodiment, is also a value calculated based at least in part on a total number of posts and a number of those posts determined to contain one or more issues. In this example, a post may be considered to contain an issue if it lacks proper attribution and/or respects brand names. For example, a post may be considered to contain an issue by searching for a phrase of a predetermined minimum length and submitting the phrase to a search engine to determine whether the phrase is original. As another example, a post may be considered to contain an issue if the post includes a trademark without use of the trademark symbol® or ™.

Data for the “future offerings” box may be similarly generated based at least in part on the number of posts and the number of posts determined to contain one or more particular issues. A post may be determined to contain an issue if the post contains information about a future product offering that is intended to remain confidential. The “future offerings” box may be generated similar to the “respect confidentiality” box, but generated also where the issues are limited to those dealing with future product offerings.

In an embodiment, any of the boxes in the reputation metric panel are selectable so as to allow a user to obtain more detailed related information. For example, by selecting a box in the reputation metric panel, the presentation 600 may update (or, generally, a UI may update) to provide information about how the corresponding reputation metric was calculated. The user may be provided, for example, data from the posts identified as issues. In an embodiment, the user is provided UI controls that enable the user to override determinations of issues. For example, a user may provide user input that indicates that a particular post (e.g. a tweet) determined to be an issue with respect to confidentiality is not actually an issue. For example, a future product offering may have a code name that coincidentally appeared in an employee's tweet on an unrelated topic. The user may indicate that the tweet is not an issue and any reputation metrics affected may be recalculated. Similarly, if the user sees a particular egregious violation of an organizational policy (e.g. leak of an acquisition candidate to the public), in an embodiment, the UI provides controls that enable the user to take appropriate action, such as by notifying an appropriate person (e.g. supervisor of the employee and/or person in the legal department) of the violation. Other enhancements are also considered as being within the scope of the present disclosure.

As shown in FIG. 6, numerous other panels are shown cascading behind the reputation metric panel 606. In an embodiment, these other panels 608 are reputation metric panels for other employees. The reputation panels may be ordered according to one or more reputation metrics, or a score that is calculated based at least in part on the reputation metrics. In some embodiments, more than one score may be presented per employee. For example, a score that ranks the user against all other employees known to the system, and a score that ranks them according to the currently selected set may both be presented. A user may interact with the user interface to change which panel appears in place of the reputation metric panel 606 for Ionia Division, thereby comparing numerous employees.

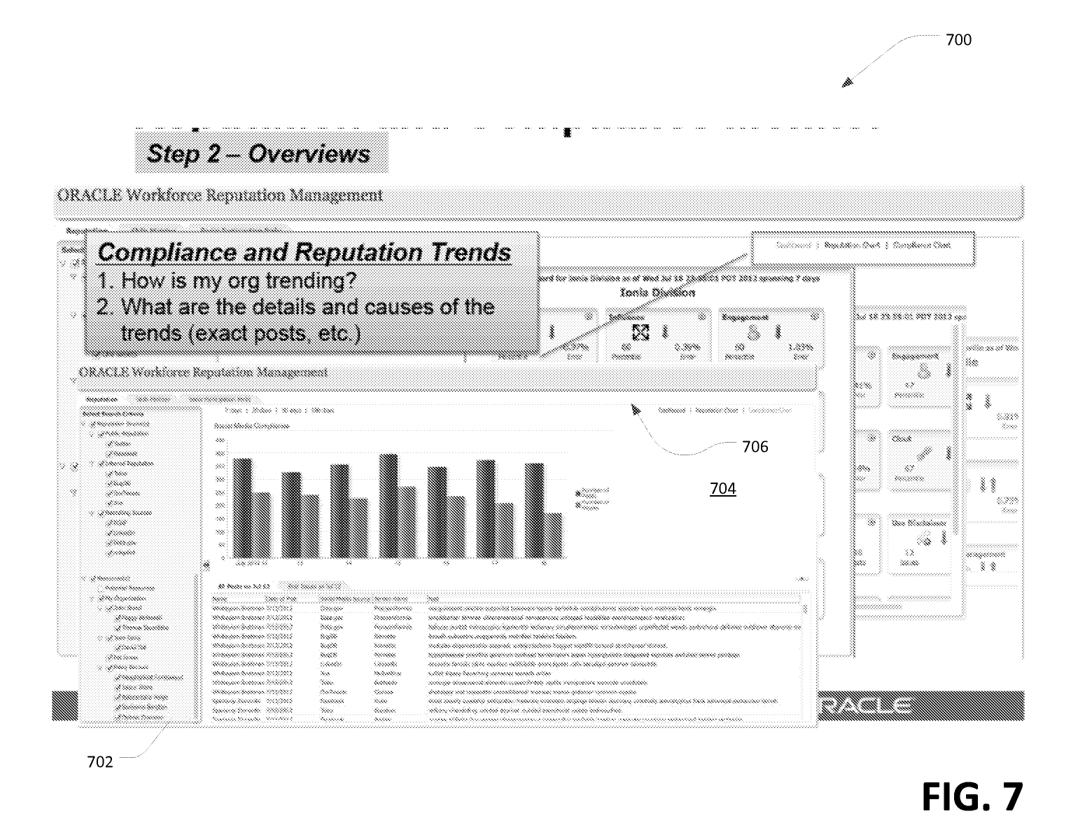

As noted, various embodiments of the present disclosure not only involve presentations relating to reputation metrics calculated for individual employees, but for groups as well, such as a complete organization or a department. FIG. 7 accordingly shows an illustrative example of a presentation 700 which shows reputation for a group, in this particular example, a whole organization.

In this example, the presentation 700 includes an overview panel 704, which provides various statistical information about members of the organization. For instance, in this particular example illustrated in FIG. 7 the overview panel 704 includes a graph illustrating statistics relating to the members of the organization's compliance with the organization's social media policy, that is, whether the members of the organization are interacting with public social networks in accordance with a policy of the organization. The policy may, for example, prohibit employees from discussing pending deals and may prohibit other activities such as by linking a profile with an employee of another organization with which the organization is dealing.

In this example, the overview panel shows, for each month, statistics calculated, and in particular, a number of social media posts for which data was obtained and the number of those posts that contain issues that are potential violations of a social media policy. In this manner a user of an application of which the user interface is a part may view trends in the organization's compliance so as to take appropriate action.

Also shown in FIG. 7 is a reputation metric panel 706 set as described above in connection with FIG. 6. In this manner, a user of an application, which is showing the presentation 700, may navigate between presentations regarding statistics calculated for a group and for an individual.

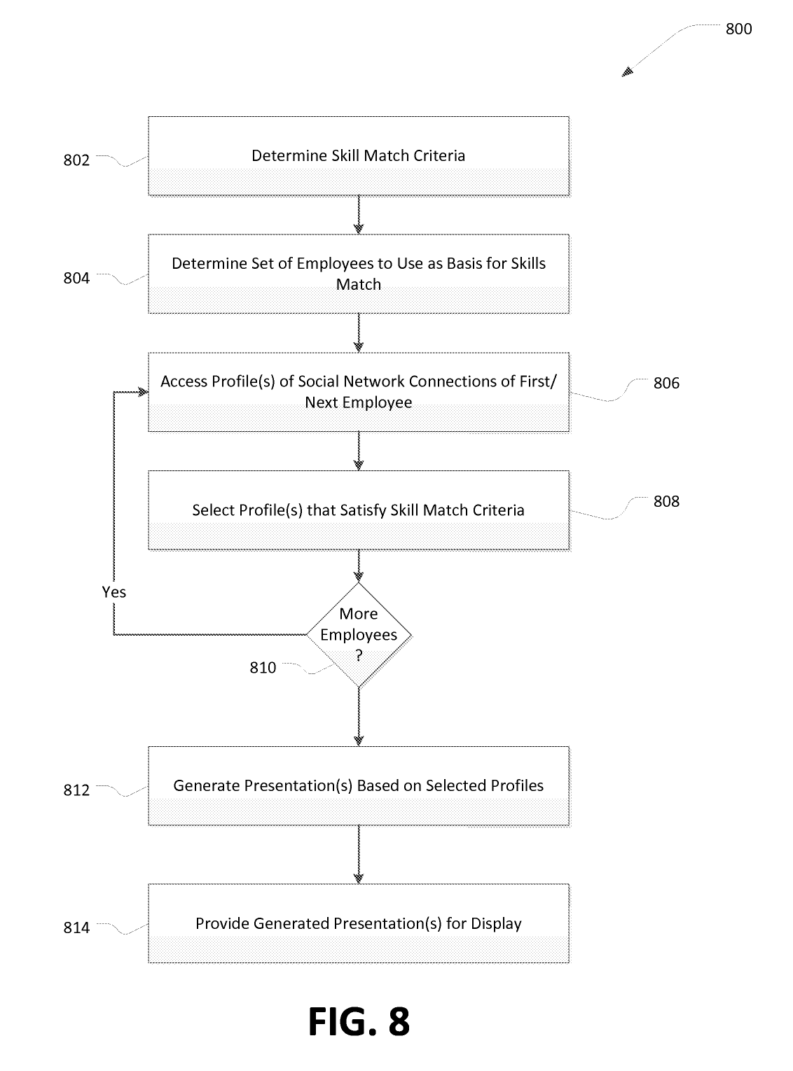

The techniques described above may also be adapted for numerous other purposes. For example, obtaining data from multiple data sources may be used, in accordance with various embodiments, to identify candidates for positions. In particular, the techniques described herein also relate to matching individuals with skills for particular positions in an organization. FIG. 8, accordingly, shows an illustrative example of a process 800 for skill matching in accordance with an embodiment. The process 800 may be performed by a suitable computing device or computing system, such as by a reputation data processing system with a corresponding user interface, such as described above.

In an embodiment, the process 800 includes determining 802 skill-match criteria. Determining the skill-match criteria may be performed in any suitable manner. For example, a user of an application executing in connection with performance of the process 300 may include a user interface that allows a user to define criteria, such as criteria for an open position within the organization. A user for example may specify that the position requires knowledge certain programming languages and/or techniques, requires experience with certain technologies, meets certain educational requirements, and the like.

Determining the skill-match criteria may also be performed in another way, such as by selecting a position or role of the organization and accessing associated criteria in a data store that have been stored in association with that position or role. In an embodiment, the process 800 includes determining 804 a set of employees to use as the basis for a skills match. For instance, if the process 800 is being performed in order to identify candidates for an attorney position in the legal department, determining the set of employees may include identifying attorneys in the legal department. Similarly, if the process 800 is being performed in order to identify candidates for a programmer position, employees in a particular department may be part of the set and/or employees matching, at least partially, the skill-match criteria may be part of the set.

In an embodiment, the process 800 includes accessing 806 one or more profiles of social network connections for a first employee. For example, if the first employee has an account with a social network, a profile of the employee may be accessed, such as through an API call, to identify profiles linked to the employee's profile. The profiles for the linked profiles may be accessed and analyzed.

It should be noted that it may or may not be possible to access complete information of the linked profiles. For example, users of social networks generally are able to change various privacy settings, the result of which may result in varying amounts of information being available. Nevertheless, performance of the process 800 may be performed by using whatever data is provided and/or otherwise available.

Once the profiles of the social network connections of the first employee are accessed and analyzed, profiles that match the skill-match criteria are selected 808. A determination is then made 810 whether there are more employees and this process may repeat. That is, for each of the determined sets of employees, social network profiles may be used to analyze links of those profiles to determine whether those profiles indicate a match with the determined skill-match criteria.

It should be noted that selecting profiles that satisfy the skill-match criteria may be performed in various ways. For instance, because of the varying amount of information available, it may be difficult to determine whether or not a particular profile satisfies a skill-match criteria. However, various techniques for analyzing information available may be used to determine a matching score.

For instance, a score may be one if there is a certain match and zero if there is not a match. A score between zero and one may determine how closely there is a match. For example, a score of 0.5 may indicate that there is data indicating that there might be a match but there might not be enough data such that the existence of a match can be definitely determined. Once it is determined 810 that there are no more employees of the determined set of employees, one or more presentations may be generated 812 based at least in part on the selected profiles. The generated profiles may then be provided 814 for display.

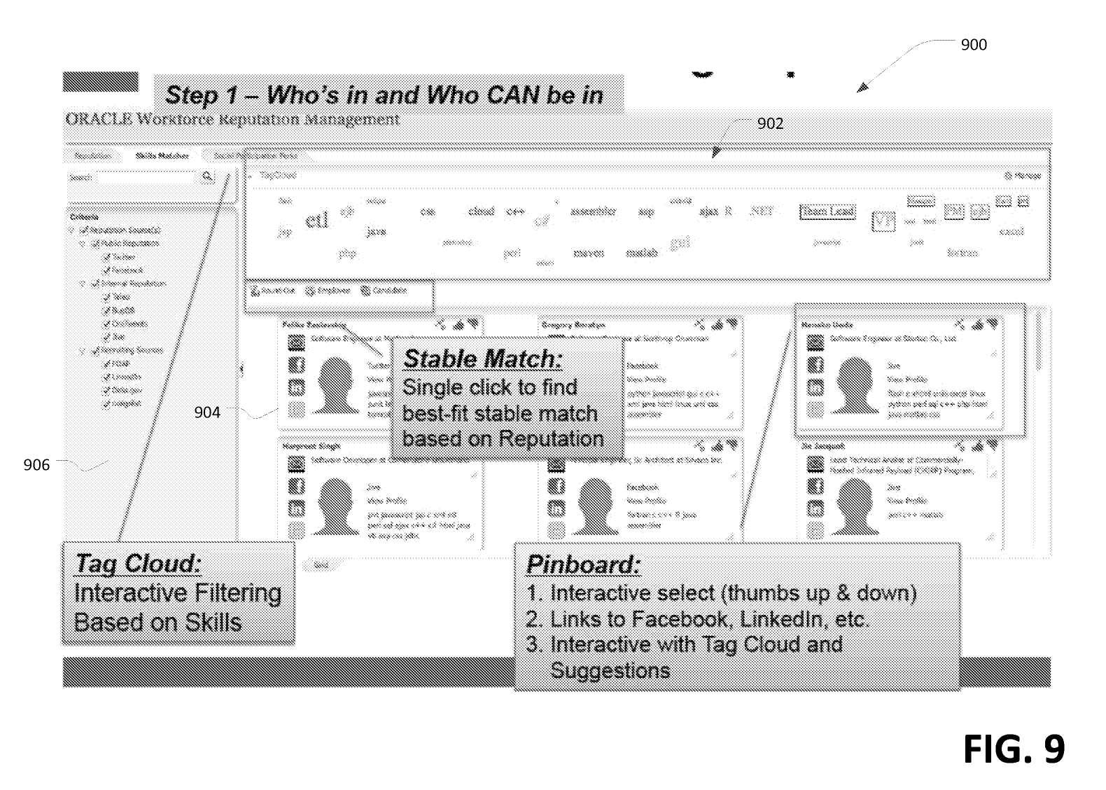

FIG. 9 shows an illustrative example of a presentation 900 which may be provided in connection with performance of the process 800 described above in connection with FIG. 8. The presentation 900 in an embodiment includes various components. For example, in an embodiment, the presentation 900 includes a tag cloud which may illustrate various terms such as described above in connection with the tag cloud described above. In this particular example, the tag cloud includes terms relating to the skills-matching criteria. The terms provided in the tag cloud may vary visually such as described above. In particular, the terms may vary based on how a particular individual or group of individuals matches the skill-match criteria. In this manner, a user of a user interface showing the presentation 900 is able to quickly and easily identify which criteria are the closest matched.

In an embodiment, the presentation 900 includes another component with a pin board 904 which includes, in this example, rectangles each corresponding to a potential candidate such as identified by the process 800 described above in connection with FIG. 8. The rectangles of the pin board 904, in an embodiment, include various information about the candidate, such as a name, links to the candidate's profile and information about the skills of the candidate. In the upper right hand corner of each rectangle is a thumbs-up and thumbs-down icon that enables a user of the application to sift through the candidates. For example, if the user does not think that a particular candidate is suitable, user may select thumbs-down, which may cause the corresponding rectangle to disappear and/or another rectangle to appear in its place. Rectangles for which thumbs-down have been selected may be later unselected through a different portion of the user interface.

Similarly, if a candidate appears particularly strong to the user, the user may select the thumbs-up icon to cause selection of the corresponding individual to be made. At a later time, the user may then filter the rectangles based on which rectangles have had the thumbs-up icon selected. A criteria component 906 of the presentation 900 is also included in order to allow the user flexibility in how the presentation is provided. The criteria may be selected and may cause the presentation 900 to update. In this particular example, the criteria include a plurality of hierarchically organized check boxes which allow user selection of various data to be used in generation of the presentation 900.

For example, the criteria may be selectable to enable a user to decide which data from which social network systems should be used, which data from which internal systems should be used, and which recruiting sources may be used. User may select and unselect criteria and, as a result, signals which are indicative of the selection may be sent to an application and the presentation 900 may be updated accordingly. For example, if the Facebook check box is unchecked, the data from the Facebook social network system may be disregarded, data may be reanalyzed and a new presentation 900 may appear in its place.

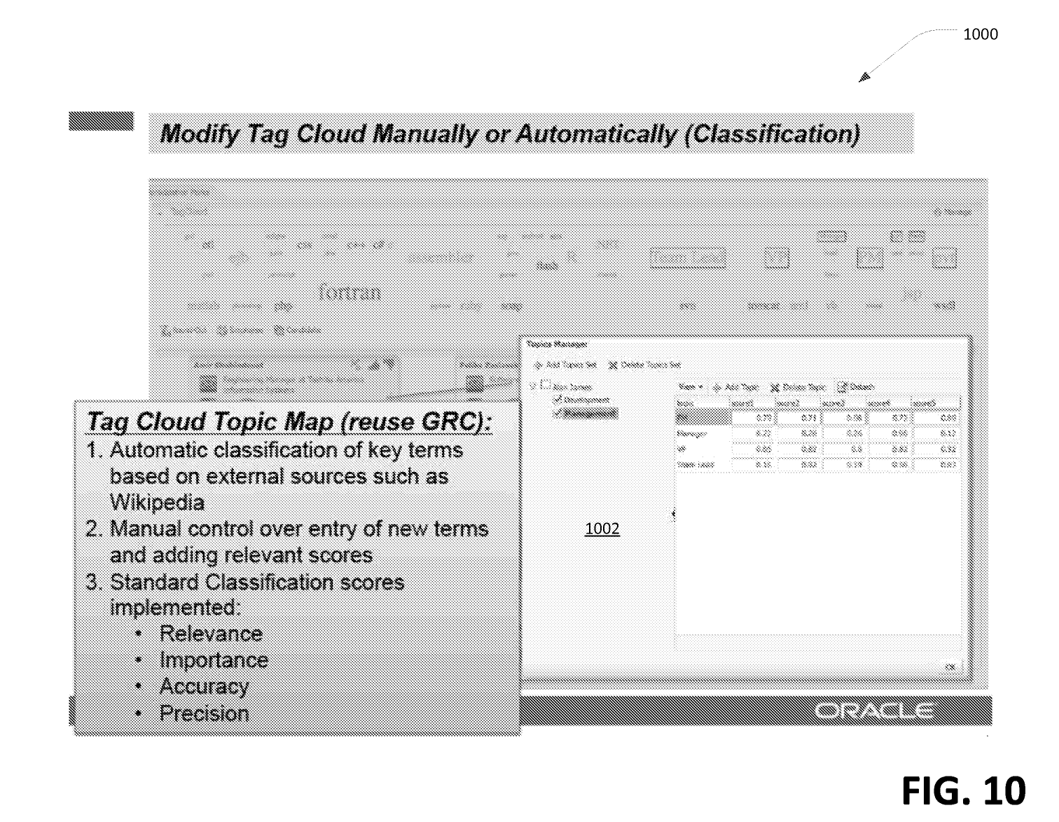

In an embodiment, the tag cloud is user-configurable. Accordingly, FIG. 10 shows an illustrative example of a presentation 1000 which may allow configuration of the tag cloud, which may be configured similarly to the tag cloud described above. In particular, the presentation 1000 includes a presentation on which a topics manager 1002 pane is overlaid.

In an embodiment, the various terms of the tag cloud, also referred to as topics, are shown in the topics manager 1002. The topics appear in a row of a table where the columns correspond to weighting values of various reputation metrics scores used to weigh the topic. Users may manually edit the scores to determine how influential they are in generating the presentation of the tag cloud.

FIG. 11 is a simplified block diagram of a computer system 1100 that may be used to practice an embodiment of the present invention. Computer system 1100 may serve as a reputation data processing system, or component computer system instance thereof, such as described above and/or a computer system that presents a user interface in accordance with the various embodiments described herein. As shown in FIG. 11, computer system 1100 includes a processor 1102 that communicates with a number of peripheral subsystems via a bus subsystem 1104. These peripheral subsystems may include a storage subsystem 1106, comprising a memory subsystem 1108 and a file storage subsystem 1110, user interface input devices 1112, user interface output devices 1114, and a network interface subsystem 1116.

Bus subsystem 1104 provides a mechanism for letting the various components and subsystems of computer system 1100 communicate with each other as intended. Although bus subsystem 1104 is shown schematically as a single bus, alternative embodiments of the bus subsystem may utilize multiple busses.

Network interface subsystem 1116 provides an interface to other computer systems, networks, and portals. Network interface subsystem 1116 serves as an interface for receiving data from and transmitting data to other systems from computer system 1100. The network interface subsystem 1116, for example, may enable the computer system 1100 to communicate with other computer systems over a network, such as to obtain data from various data sources and/or to communicate with other components of a reputation data processing system.

User interface input devices 1112 may include a keyboard; pointing devices such as a mouse, trackball, touchpad, or graphics tablet; a scanner; a barcode scanner; a touch screen incorporated into the display; audio input devices such as voice recognition systems; microphones; and other types of input devices. In general, use of the term “input device” is intended to include all possible types of devices and mechanisms for inputting information to computer system 1100. A user may use an input device to provide user input to interact with a user interface to perform various activities described above.

User interface output devices 1114 may include a display subsystem, a printer, a fax machine, or non-visual displays such as audio output devices, etc. The display subsystem may be a cathode ray tube (CRT), a flat-panel device such as a liquid crystal display (LCD), a light emitting diode (LED) display, a projection device, and/or another device capable of presenting information. In general, use of the term “output device” is intended to include all possible types of devices and mechanisms for outputting information from computer system 1100. Presentations generated in accordance with the various embodiments described herein, for example, may be presented using output devices 1114.

Storage subsystem 1106 provides a computer-readable medium for storing the basic programming and data constructs that provide the functionality of the present invention. Software (programs, code modules, instructions) that, when executed by a processor, provide the functionality of the present invention may be stored in storage subsystem 1106. These software modules or instructions may be executed by processor(s) 1102. Storage subsystem 1106 may also provide a repository for storing data used in accordance with the present invention, for example, the data stored in the diagnostic data repository. For example, storage subsystem 1106 provides a storage medium for persisting data that is analyzed to calculate various reputation metrics and/or reputation values. Storage subsystem 1106 may comprise memory subsystem 1108 and file/disk storage subsystem 1110.

Memory subsystem 1108 may include a number of memory components including a main random access memory (RAM) 1118 for storage of instructions and data during program execution and a read-only memory (ROM) 1120 in which fixed instructions are stored. File storage subsystem 1110 provides persistent (non-volatile) storage for program and data files, and may include a hard disk drive, a floppy disk drive along with associated removable media, a Compact Disk Read-Only Memory (CD-ROM) drive, an optical drive, removable media cartridges, and other like storage media.

Computer system 1100 can be of various types including a personal computer, a portable computer, a smartphone, a table computing device, a workstation, a network computer, a mainframe, a kiosk, a server or any other data processing system. Due to the ever-changing nature of computers and networks, the description of computer system 1100 depicted in FIG. 11 is intended only as a specific example for purposes of illustrating the preferred embodiment of the computer system. Many other configurations having more or fewer components than the system depicted in FIG. 11 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims.

What is claimed is:

1. A method for reputation management of employees of an enterprise, the method comprising:
obtaining activity data for each of a plurality of employees from each of a plurality of data sources, wherein the plurality of data sources include at least one data source internal to the enterprise and at least one data source external to the enterprise; and
calculating a reputation score for at least one of the plurality of employees, the reputation score based at least in part on the obtained activity data.

2. The method of claim 1, wherein obtaining activity data for each of the plurality of employees comprises:
receiving the activity data from each of the plurality of data sources;
converting the received activity data; and
storing the converted activity data.

3. The method of claim 2, wherein converting the received activity data comprises:
identifying a portion of the converted activity data as relevant; and
discarding a portion of the converted activity data other than the portion identified as relevant.

4. The method of claim 2, wherein converting the received activity data comprises converting the received activity data to a common organizational schema.

5. The method of claim 2, wherein calculating the reputation score for at least one of the plurality of employees comprises:
accessing the stored activity data;
calculating one or more reputation metrics for the at least one of the plurality of employees based at least in part on the accessed activity data; and
calculating the reputation score for the at least one of the plurality of employees based at least in part on the calculated one or more reputation metrics.

6. The method of claim 5, wherein the one or more reputation metrics comprise a plurality of reputation metrics, wherein calculating the reputation score for the at least one of the plurality of employees comprises calculating a weighted sum of the reputation metrics, and wherein a weight of each of the reputation metrics is user-configurable.

7. The method of claim 5, further comprising:
receiving an indication of one or more selected employees of the plurality of employees;
accessing the reputation metrics of the one or more selected employees;
generating a presentation based on the accessed reputation metrics; and
providing the generated presentation to a user.

8. A system comprising:
a processor; and
a memory coupled with and readable by the processor and storing a set of instructions which, when executed by a processor, cause the processor to manage reputations by:
obtaining activity data for each of a plurality of employees from each of a plurality of data sources, wherein the plurality of data sources include at least one data source internal to the enterprise and at least one data source external to the enterprise; and
calculating a reputation score for at least one of the plurality of employees, the reputation score based at least in part on the obtained activity data.

9. The system of claim 8, wherein obtaining activity data for each of the plurality of employees comprises:
receiving the activity data from each of the plurality of data sources;
converting the received activity data; and
storing the converted activity data.

10. The system of claim 9, wherein converting the received activity data comprises:
identifying a portion of the converted activity data as relevant; and
discarding a portion of the converted activity data other than the portion identified as relevant.

11. The system of claim 9, wherein converting the received activity data comprises converting the received activity data to a common organizational schema.

12. The system of claim 9, wherein calculating the reputation score for at least one of the plurality of employees comprises:
accessing the stored activity data;
calculating one or more reputation metrics for the at least one of the plurality of employees based at least in part on the accessed activity data; and
calculating the reputation score for the at least one of the plurality of employees based at least in part on the calculated one or more reputation metrics.

13. The system of claim 12, wherein the one or more reputation metrics comprise a plurality of reputation metrics, wherein calculating the reputation score for the at least one of the plurality of employees comprises calculating a weighted sum of the reputation metrics, and wherein a weight of each of the reputation metrics is user-configurable.

14. The system of claim 12, further comprising:
receiving an indication of one or more selected employees of the plurality of employees;
accessing the reputation metrics of the one or more selected employees;
generating a presentation based on the accessed reputation metrics; and
providing the generated presentation to a user.

15. A computer-readable memory comprising a set of instructions stored therein which, when executed by a processor, causes the processor to manage reputations by:
obtaining activity data for each of a plurality of employees from each of a plurality of data sources, wherein the plurality of data sources include at least one data source internal to the enterprise and at least one data source external to the enterprise, wherein obtaining activity data for each of the plurality of employees comprises receiving the activity data from each of the plurality of data sources, converting the received activity data, and storing the converted activity data; and
calculating a reputation score for at least one of the plurality of employees, the reputation score based at least in part on the obtained activity data.

16. The computer-readable memory of claim 15, wherein converting the received activity data comprises:
identifying a portion of the converted activity data as relevant; and
discarding a portion of the converted activity data other than the portion identified as relevant.

17. The computer-readable memory of claim 15, wherein converting the received activity data comprises converting the received activity data to a common organizational schema.

18. The computer-readable memory of claim 15, wherein calculating the reputation score for at least one of the plurality of employees comprises:
accessing the stored activity data;
calculating one or more reputation metrics for the at least one of the plurality of employees based at least in part on the accessed activity data; and
calculating the reputation score for the at least one of the plurality of employees based at least in part on the calculated one or more reputation metrics.

19. The computer-readable memory of claim 18, wherein the one or more reputation metrics comprise a plurality of reputation metrics, wherein calculating the reputation score for the at least one of the plurality of employees comprises calculating a weighted sum of the reputation metrics, and wherein a weight of each of the reputation metrics is user-configurable.

20. The computer-readable memory of claim 18, further comprising:
receiving an indication of one or more selected employees of the plurality of employees;
accessing the reputation metrics of the one or more selected employees;
generating a presentation based on the accessed reputation metrics; and
providing the generated presentation to a user.
